(19) United States
(12) Patent Application Publication
(10) Pub. No.: US 2025/0309266 A1
(43) Pub. Date: Oct. 2, 2025

(54) SILICON-CARBON ELECTRODE MATERIAL

(71) Applicant: FORD GLOBAL TECHNOLOGIES, LLC, Dearborn, MI (US)

(72) Inventors: Zijie LU, Novi, MI (US); Haibo ZHAO, Northville, MI (US); Hannah Jane LOIZZO-JAY, Southfield, MI (US); Andrew Robert DREWS, Ann Arbor, MI (US)

(21) Appl. No.: 18/616,294

(22) Filed: Mar. 26, 2024

(51) Int. Cl. H01M 4/587; H01M 4/02; H01M 4/04; H01M 4/136; H01M 4/1397; H01M 10/0525

(52) U.S. Cl. CPC H01M 4/587; H01M 4/0404; H01M 4/136; H01M 4/1397; H01M 10/0525; H01M 2004/021

(57) ABSTRACT

According to one aspect of the disclosure, a lithium-ion battery component is presented. The lithium-ion battery component has an electrode with a current collector, and a silicon-based active layer adhered thereon. The silicon-based active layer includes coated silicon beads connected by carbon chains to form fiberized conductive silicon-carbon necklaces that are configured to confine the silicon beads via the carbon chains during volume expansion and contraction of the electrode during charge cycling.

### TECHNICAL FIELD

The disclosure relates to electrode materials for lithium-ion batteries.

### BACKGROUND

Silicon, due to its theoretically high lithium storage capacity of 4200 mAh/g, low potential of about 0.3 V versus Li+/Li, and natural abundance, has emerged as a promising candidate for high-capacity anode material in solid-state batteries. However, despite these appealing attributes, the widespread commercialization of silicon anodes, especially those with high silicon content (above 40 wt. %), has been hindered by several challenges. One of the primary obstacles is the volume expansion that silicon undergoes upon charging. This expansion, a consequence of phase transitions and changes in the lattice volume, often leads to the breakdown of silicon particles, a phenomenon known as pulverization. Pulverization is responsible for various performance degradation mechanisms in silicon anodes, such as the loss of electronic and ionic conducting paths, electrode delamination, the formation of cracks and voids, and the continuous reforming of the solid electrolyte interface (SEI).

Research indicates that reducing silicon particle size to below a certain threshold can mitigate pulverization. For crystalline silicon, this size is approximately 150 nm, with particles exceeding this size being prone to pulverization. Consequently, the majority of research and development efforts in silicon anode technology are directed towards utilizing nanosized silicon particles. While the nanosizing of silicon particles enhances cycle stability, it also leads to decreased material availability. Micron-sized silicon particles are preferred for their reduced SEI formation. Strategies to use silicon particles larger than the threshold, including micron-sized particles, may enable the broader adoption of silicon-based solid-state battery technology. Additionally, the low electronic conductivity of silicon, which is on the order of 10\hat{ }−5 S/cm, poses another challenge. This underscores the need for significant advancements in enhancing the electronic conductivity of silicon particles to overcome the limitations faced by silicon anodes in solid-state batteries.

### SUMMARY

According to one aspect of the disclosure, a lithium-ion battery component is presented. The lithium-ion battery component has an electrode with a current collector, and a silicon-based active layer adhered thereon. The silicon-based active layer includes coated silicon beads connected by carbon chains to form fiberized conductive silicon-carbon necklaces that are configured to confine the silicon beads via the carbon chains during volume expansion and contraction of the electrode during charge cycling. The silicon-carbon necklaces may have a diameter of 0.1-10 um. The silicon-carbon necklaces may have a length of less than 100 microns. In some configurations, the silicon-carbon necklaces have a length of less than 10 microns. The silicon-carbon necklaces may have a silicon content range of 30-80 wt. %. The silicon beads may have a diameter greater than 100 nm.

In another aspect of the disclosure, a solid-state battery is presented. The solid-state battery includes a separator, and a pair of electrodes sandwiching the separator. At least one of the electrodes includes a silicon-based active layer with silicon particles encapsulated and conductively interconnected by carbon chains that are configured to maintain conductive contact among the silicon particles in a lithiated state. The silicon-based active layer may include a carbon additive. The silicon-based active layer may include solid electrolyte. The solid electrolyte may be sulfide-based. The silicon-based active layer may have a silicon content range of 30-80 wt. %. The silicon particles may have a diameter greater than 100 nm.

In yet another aspect of the disclosure, a method is presented. The method begins with electrospinning a solution of dissolved silicon precursors and carbon precursors to form an agglomeration of silicon-carbon necklaces each defined by coated silicon beads linked by a carbon chain. Then carbonizing the silicon-carbon necklaces to form carbonized silicon-carbon necklaces. Finally, fiberizing the carbonized silicon-carbon necklaces to form fiberized silicon-carbon necklaces. The silicon precursors and carbon precursors may be dissolved in dimethylformamide. The agglomeration may contain 13 wt. % of silicon precursors. The silicon precursors and the carbon precursors may be present in a ratio of 1:2 by weight. The silicon precursors may have an average diameter of 400 nm. In some configurations, the method may further include mixing the fiberized silicon-carbon necklaces with solid electrolyte particles, carbon additives, and polymeric binders to form a slurry. The slurry may be coated onto a current collector and cured to form an anode. The anode may be packed with a separator and a cathode to form a solid-state battery.

### BRIEF DESCRIPTION OF THE DRAWINGS

FIG. 1A is a graph showing the effect of particle size on first cycle voltage;

FIG. 1B is a table of the effect of particle size on capacity and coulombic efficiency;

FIG. 1C is a graph of the effect of particle size on discharge capacity;

FIG. 2A is a graph of the cycle stability of a currently available silicon-carbon composite;

FIG. 2B is a graph of the internal resistance of a currently available silicon-carbon composite;

FIG. 3 is a schematic diagram of a lithium-ion battery according to one or more embodiments of the disclosure;

FIG. 4 is a schematic diagram of a lithium-ion battery component according to one or more embodiments of the disclosure;

FIGS. 5A and 5B are schematic diagrams of silicon-carbon necklaces according to one or more embodiments of the disclosure;

FIGS. 6A and 6B are schematic diagrams of silicon-carbon necklaces according to one or more embodiments of the disclosure;

FIG. 7A is a graph showing capacity retention of an electrode with silicon-carbon necklaces according to one or more embodiments of the disclosure;

FIG. 7B is a graph showing voltage profile of an electrode with silicon-carbon necklaces according to one or more embodiments of the disclosure;

FIG. 7C is a graph showing differential capacity of an electrode with silicon-carbon necklaces according to one or more embodiments of the disclosure; and

FIG. 8 is a flow chart of a method of manufacturing fiberized silicon-carbon necklaces according to one or more embodiments of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure relates to a silicon-carbon material and its method of fabrication. The silicon-carbon composite may be configured to increase cycle stability of silicon-based anodes in solid-state batteries. The silicon-carbon composite may have a “necklace-like” morphology, wherein silicon domains are coated with a carbon layer and interconnected by carbon nanofibers. This electron transport across the electrode may also provide mechanical support to the silicon domains, allowing them to withstand the pressures induced by volume expansion during the battery's charge and discharge cycles. The silicon-carbon composite may also increase the electric conductivity and mechanical integrity of particulate materials within the battery, leading to increased cycle stability and overall battery performance. The design of this composite also aims to mitigate solid electrolyte interface (SEI) formation. By limiting the growth of the SEI layer, the composite helps to maintain the electrode's ionic conductivity and structural integrity through numerous cycles.

In one aspect of the disclosure, the composition of a precursor solution for fabricating silicon-carbon necklaces is presented. This composition is determined to be 13 wt. % solids in dimethylformamide (DMF), with a ratio of silicon nanoparticles (SiNPs) to polyacrylonitrile (PAN) of 1:2, and 400 nm silicon nanoparticles. This formulation is used in achieving the “necklace-like” morphology of the silicon-carbon composite, which plays a role in increasing the cycle stability of silicon-based anodes in solid-state batteries. The silicon domains within the composite are coated uniformly by the precursor solution with a carbon layer and interconnected by carbon nanofibers. This structure facilitates electron transport across the electrode and provides mechanical support to the silicon domains. This support may accommodate the pressures induced by volume expansion during the battery's charge and discharge cycles, thereby reducing mechanical degradation and loss of electrical connectivity within the electrode.

The fabrication of the silicon-carbon necklaces can be done by electrospinning, where a mixture of silicon precursors and carbon precursors is spun, followed by a carbonization process to solidify the structure. Alternatively, these particles may also be generated using an extrusion process, which involves the extrusion of similar precursor mixtures. Both methods uniformly coat the silicon domains within the composite with a carbon layer and interconnect them with carbon nanofibers, creating a robust framework that supports electron transport and mechanical integrity under operational cycling.

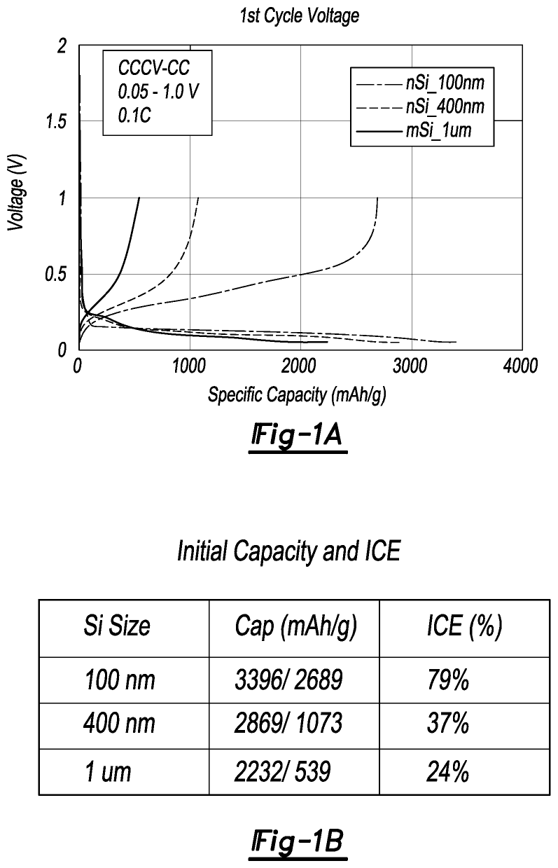

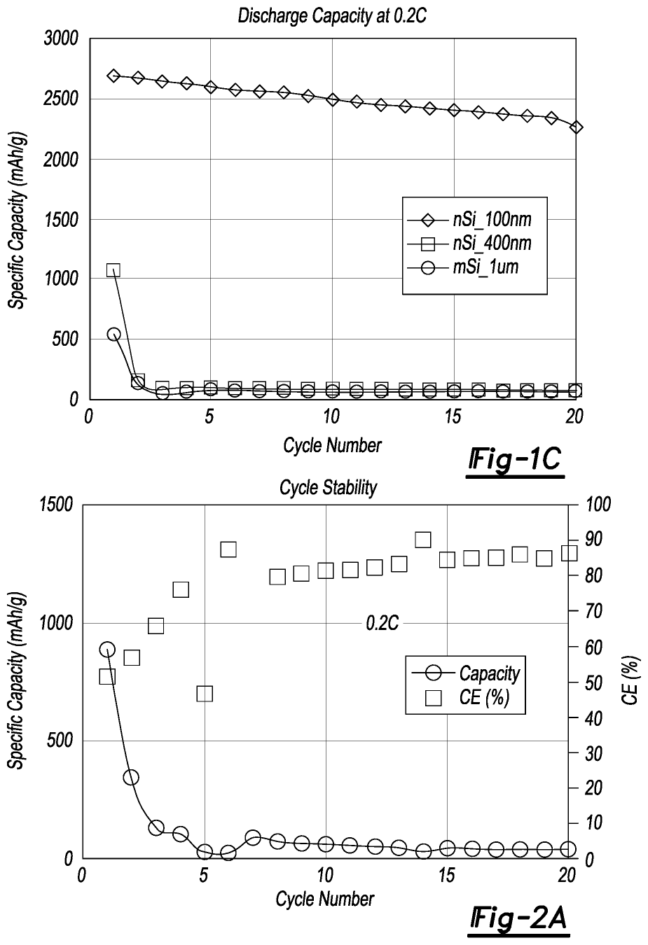

An experiment was set up to characterize the effect of silicon particle size on the electrochemical properties of a solid-state battery cell. Silicon was loaded at a density of 1.4 mg/cm\hat{ }2 into three test samples with silicon particle sizes of 100 nm, 400 nm, and 1 um. In FIG. 1A, a graph showing the effect of particle size on the first cycle voltage is presented. The first cycle voltage is observed to be related to the particle size of silicon used. A significant increase in results was shown for the sample containing 100 nm particle size silicon. In FIG. 1B, a table of the effect of particle size on capacity and Coulombic efficiency is presented. Similarly, it can be observed that the sample with 100 nm particles of silicon has a higher capacity and internal Coulombic efficiency compared to the samples with 400 nm and 1 um particles of silicon, respectively. FIG. 1C is a graph of the effect of particle size on discharge capacity. The sample with 100 nm particles of silicon has an increased discharge capacity at 0.2C compared to the samples with 400 nm and 1 um particles of silicon, respectively.

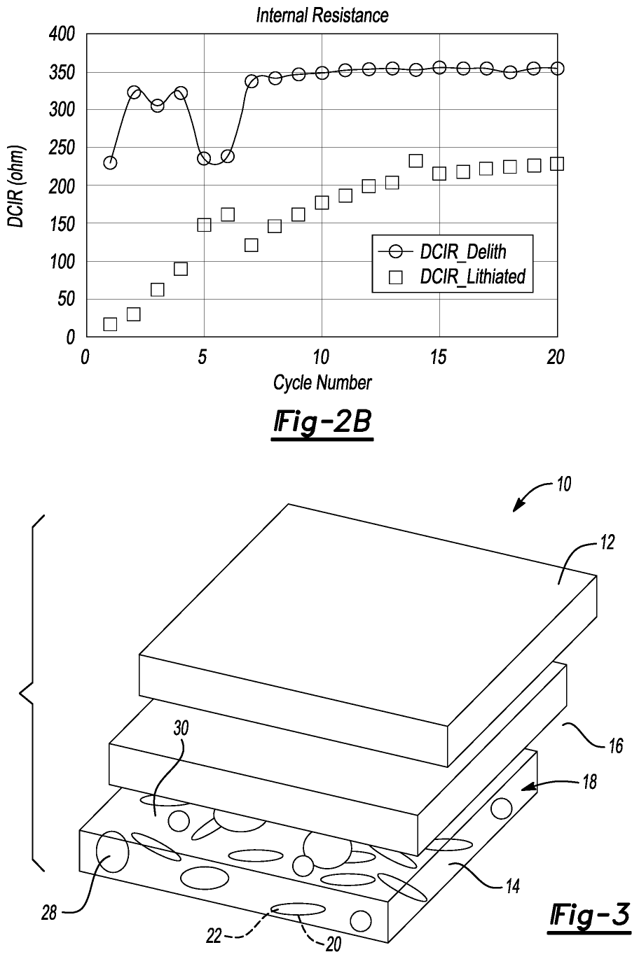

In another test setup, current commercially available silicon-carbon material was evaluated for its performance in a de-lithiated and a lithiated state. The silicon-carbon material was loaded into a half-cell with solid electrolyte pellets and lithium at a density of 1.35 mg/cm\hat{ }2. FIG. 2A is a graph of the cycle stability of the currently available silicon-carbon composite in its lithiated and de-lithiated states. FIG. 2B is a graph of the internal resistance of the commercially available silicon-carbon composite. The silicon-carbon material that is commercially available exhibits poor cycle performance. The rapid capacity decay is attributable to the loss of conducting paths, which is reflected in the constant increase of direct current internal resistance (DC-IR) in the fully lithiated state.

Referring now to FIGS. 3-6B, FIG. 3 is a schematic diagram of a lithium-ion battery 10 according to one or more embodiments of the disclosure. The lithium-ion battery 10 shown is a solid-state battery 10 with a pair of lithium-ion battery components 12 and 14 sandwiching a separator 16. Lithium-ion battery component 14 is shown as an electrode which includes a silicon-based active layer 18 with silicon particles 20 encapsulated and conductively interconnected by carbon chains 22. The silicon particles 20 have a diameter greater than 100 nm. The carbon chains 22 are configured to maintain conductive contact among the silicon particles in a lithiated state. As shown the silicon-based active layer 18 is incorporated into the lithium-ion battery component 14 that is an electrode serving as an anode.

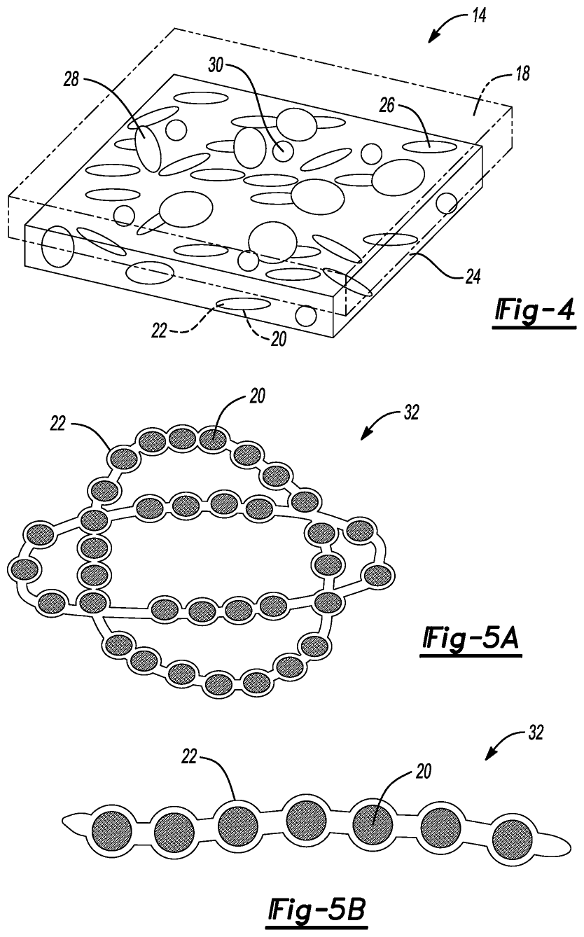

FIG. 4 shows the electrode 14 having a current collector 24, and the silicon-based active layer 18 adhered thereon. The silicon-based active layer 18 includes coated silicon beads 20 connected by carbon chains 22 to form fiberized conductive-silicon carbon necklaces 26. The silicon-carbon necklaces 26 are configured to confine the silicon beads 20 via the carbon chains 22 during volume expansion and contraction of the electrode 14 during charge cycling. In some configurations, the silicon-carbon necklaces 26 may have diameters within the range of 0.1 to 10 um, and lengths that may be less than 100 microns. In certain embodiments, the lengths of these necklaces 26 may be less than 10 microns. Additionally, the silicon content within the silicon-carbon necklaces 26 is targeted to be within the range of 30 to 80 wt. %, depending on the specific application and desired electrochemical performance in solid-state batteries. The silicon-based active layer 18 is also shown to include solid electrolyte particles 28 and carbon additive 30. The solid electrolyte particles 28 may be sulfide particles.

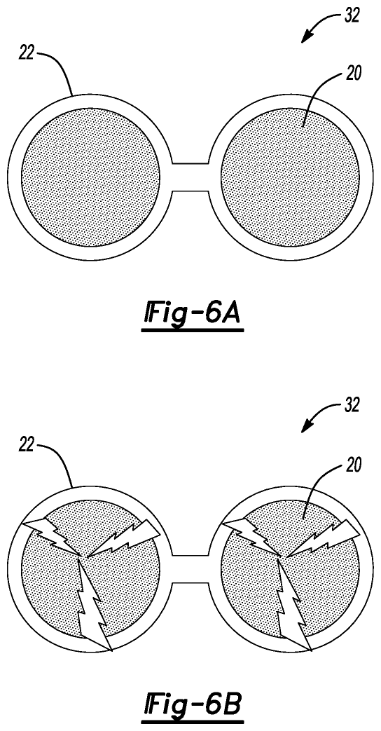

FIG. 5A shows a silicon-carbon necklace 32 with coated silicon beads 20 connected by carbon chains 22 in a closed necklace formation. However, the silicon-carbon necklace 32 may also be in an open configuration as shown in FIG. 5B. FIG. 6A shows the silicon-carbon necklace 32 in a de-lithiated state. As the lithiation process takes place, silicon particles 20 that break apart due to volume expansion, maintain conductive contact due to the carbon chains 22 as shown in FIG. 6B.

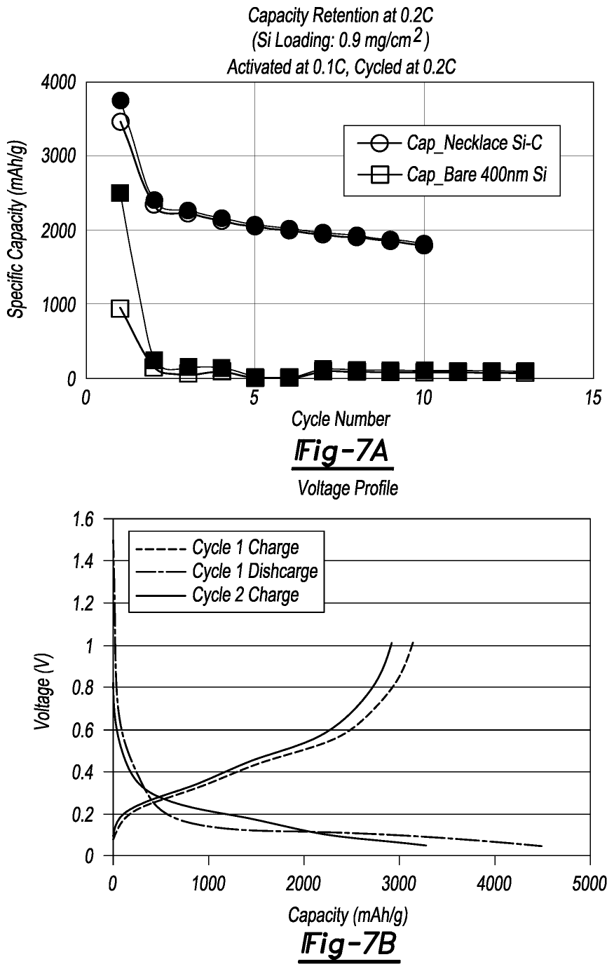

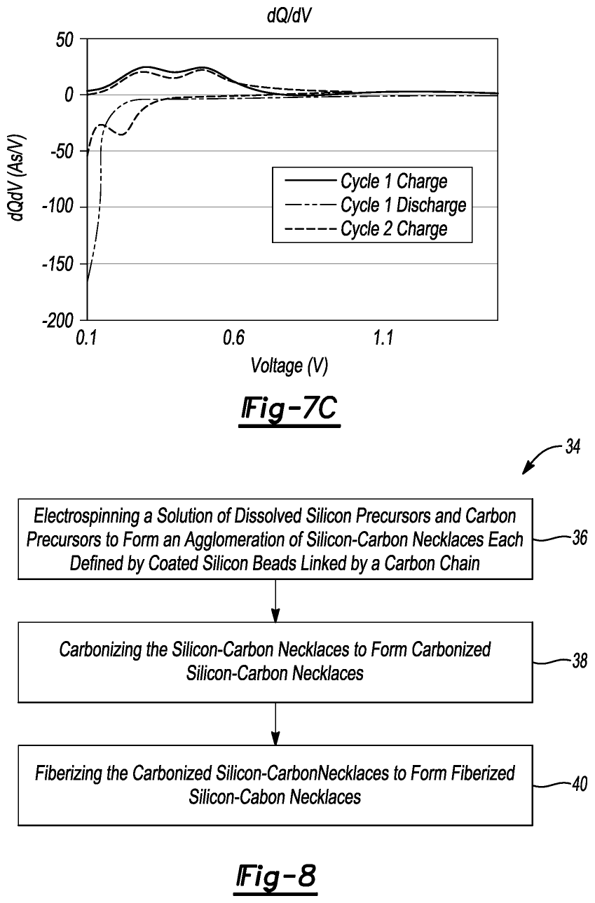

FIGS. 7A-C show experimental results on the performance of a lithium-ion battery using silicon-carbon necklaces 26. Compared to batteries with bare silicon particles, those incorporating silicon-carbon necklaces 26 exhibit higher capacity and capacity retention, as evident in FIGS. 7A and 7B. This increase is attributed to the structural stability of the silicon-carbon necklaces 26, which mitigates the effects of volume changes during cycling. FIG. 7C shows stable differential capacity (dQ/dV) peaks, indicating consistent electrochemical behavior. These results were obtained from a half-cell configuration with a silicon loading of 0.9 mg/cm\hat{ }2.

FIG. 8 is a flowchart of a method of manufacturing fiberized silicon-carbon necklaces 34 according to one or more embodiments of the disclosure. Block 36 begins with electrospinning a solution of dissolved silicon precursors and carbon precursors to form an agglomeration of silicon-carbon necklaces each defined by coated silicon beads linked by a carbon chain. Then, in block 38, carbonizing the silicon-carbon necklaces to form carbonized silicon-carbon necklaces. Finally in block 40, fiberizing the carbonized silicon-carbon necklaces to form fiberized silicon-carbon necklaces. The silicon precursors and carbon precursors may be dissolved in a solvent such as dimethylformamide or any other suitable solvent. The agglomeration may contain 13 wt. % of silicon precursors. The silicon precursors and the carbon precursors may be mixed in a ratio of 1:2 by weight. The silicon precursors may have an average diameter of 400 nm. In some configurations, the method may further include mixing the fiberized silicon-carbon necklaces with solid electrolyte particles, carbon additives, and polymeric binders to form a slurry. The slurry may then be applied as a coating onto a current collector and cured to form an anode. The method then includes packing the anode with a separator and a cathode to form a solid-state battery.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A lithium-ion battery component comprising:
an electrode having a current collector, and a silicon-based active layer adhered thereon including coated silicon beads connected by carbon chains to form fiberized conductive silicon-carbon necklaces that are configured to confine the coated silicon beads via the carbon chains during volume expansion and contraction of the electrode during charge cycling.

2. The lithium-ion battery component of claim 1 wherein the fiberized conductive silicon-carbon necklaces have a diameter of 0.1-10 um.

3. The lithium-ion battery component of claim 1 wherein the fiberized conductive silicon-carbon necklaces have a length of less than 100 microns.

4. The lithium-ion battery component of claim 1 wherein the fiberized conductive silicon-carbon necklaces have a length of less than 10 microns.

5. The lithium-ion battery component of claim 1 wherein the fiberized conductive silicon-carbon necklaces have a silicon content range of 30-80 wt. %.

6. The lithium-ion battery component of claim 1 wherein the coated silicon beads have a diameter greater than 100 nm.

7. A solid-state battery comprising:
a separator; and
a pair of electrodes sandwiching the separator, at least one of the electrodes including a silicon-based active layer with silicon particles encapsulated and conductively interconnected by carbon chains that are configured to maintain conductive contact among the silicon particles in a lithiated state.

8. The solid-state battery of claim 7 wherein the silicon-based active layer includes carbon additive.

9. The solid-state battery of claim 7 wherein the silicon-based active layer includes a solid electrolyte.

10. The solid-state battery of claim 9 wherein the solid electrolyte is sulfide-based.

11. The solid-state battery of claim 7 wherein the silicon-based active layer is 30-80 wt. % silicon particles.

12. The solid-state battery of claim 7 wherein the silicon particles have a diameter greater than 100 nm.

13. A method comprising:
electrospinning a solution of dissolved silicon precursors and carbon precursors to form an agglomeration of silicon-carbon necklaces each defined by coated silicon beads linked by a carbon chain;
carbonizing the agglomeration of silicon-carbon necklaces to form carbonized silicon-carbon necklaces; and
fiberizing the carbonized silicon-carbon necklaces to form fiberized silicon-carbon necklaces.

14. The method of claim 13 wherein the dissolved silicon precursors and carbon precursors are dissolved in dimethylformamide.

15. The method of claim 13 wherein the agglomeration of silicon-carbon necklaces contains 13 wt. % of silicon precursors.

16. The method of claim 13 wherein the dissolved silicon precursors and carbon precursors are present in a ratio of 1:2 by weight.

17. The method of claim 13 wherein particles of the dissolved silicon precursors have an average diameter of 400 nm.

18. The method of claim 13, further comprising mixing the fiberized silicon-carbon necklaces with solid electrolyte particles, carbon additives, and polymeric binders to form a slurry.

19. The method of claim 18, further comprising coating the slurry onto a current collector and curing to form an anode.

20. The method of claim 19, further comprising packing the anode with a separator and a cathode to form a solid-state battery.
